(19) United States
(12) Patent Application Publication
(10) Pub. No.: US 2026/0058281 A1
(43) Pub. Date: Feb. 26, 2026

(54) POWER STORAGE DEVICE AND METHOD FOR MANUFACTURING THE SAME

(71) Applicant: TOYOTA JIDOSHA KABUSHIKI KAISHA, Toyota-shi (JP)

(72) Inventors: Taro MATSUSHITA, Toyokawa-shi (JP); Hiroki YAMATO, Kariya-shi (JP)

(73) Assignee: TOYOTA JIDOSHA KABUSHIKI KAISHA, Toyota-shi (JP)

(21) Appl. No.: 19/254,774

(22) Filed: Jun. 30, 2025

(30) Foreign Application Priority Data
Aug. 23, 2024 (JP) 2024-143472

(51) Int. Cl. H01M 50/244; H01M 10/613; H01M 10/653; H01M 50/209; H01M 50/258; H01M 50/264

(52) U.S. Cl. CPC H01M 50/244; H01M 10/613; H01M 10/653; H01M 50/209; H01M 50/258; H01M 50/264

(57) ABSTRACT

A power storage device includes a battery case serving as a housing, and a battery module configured to be insertable in a first direction from an opening of the battery case. In addition, the power storage device includes a heat conduction member disposed between a lower surface portion of the battery module and the battery case. Furthermore, the power storage device includes a protrusion provided on a front surface portion (a rear surface portion) of the battery module and a guide portion provided on an inner surface portion of the battery case. The guide portion is configured to include a linear portion that guides the protrusion along the first direction, and an inclined portion that is provided on one side in the first direction with respect to the linear portion and extends in an inclined manner toward a side of the lower surface portion.

### CROSS-REFERENCE TO RELATED APPLICATION

This application claims priority to Japanese Patent Application No. 2024-143472 filed on Aug. 23, 2024. The disclosure of the above-identified application, including the specification, drawings, and claims, is incorporated by reference herein in its entirety.

### BACKGROUND

### 1. Technical Field

The present disclosure relates to a power storage device and a method for manufacturing the power storage device.

### 2. Description of Related Art

Japanese Unexamined Patent Application Publication No. 2015-153743 (JP 2015-153743 A) discloses a power storage device in which a heat conduction sheet is disposed between a bottom surface of a battery cell and a cooling plate. The power storage device includes an assembly member for pressing a battery module including a plurality of the battery cells against the heat conduction sheet.

### SUMMARY

In the technology described in JP 2015-153743 A, a separately configured assembly member is used to press the battery module against the heat conduction sheet, which increases the number of components. Therefore, the above prior art has room for improvement in the respect.

In consideration of the above facts, an object of the present disclosure is to obtain a power storage device and a method for manufacturing the power storage device that can press a battery module against a heat conduction member without using a separately configured member.

A power storage device of a first aspect of the present disclosure includes: a battery case serving as a housing; at least one battery module configured to be insertable in a first direction from an opening of the battery case and accommodated inside the battery case; a heat conduction member disposed between the battery case and a first surface portion of the battery module in a state in which the battery module is accommodated in the battery case, the first surface portion constituting a surface portion disposed along the first direction; and a protrusion and a guide portion, the protrusion being provided on one of a second surface portion of the battery module and an inner surface portion of the battery case, the second surface portion constituting a surface portion disposed along the first direction, the inner surface portion constituting an inner surface facing the second surface portion, and the guide portion being provided on another one of the second surface portion and the inner surface portion, in which the guide portion is configured to include a linear portion that guides the protrusion along the first direction, and an inclined portion that is provided on one side in the first direction with respect to the linear portion and extends in an inclined manner toward a side of the first surface portion.

The power storage device of the first aspect includes a battery case serving as a housing, and at least one battery module configured to be insertable in a first direction from an opening of the battery case and accommodated inside the battery case. Further, the power storage device includes a heat conduction member disposed between the battery module and the battery case in a state in which the battery module is accommodated in the battery case. The heat conduction member is disposed between the battery case and a first surface portion of the battery module, and the first surface portion constitutes a surface portion disposed along the first direction. As a result, heat generated during charging and discharging of the battery module is transferred to the battery case via the heat conduction member and dissipated from the battery case to the outside, thereby cooling the battery module.

Here, the power storage device includes a protrusion and a guide portion, the protrusion is provided on one of a second surface portion of the battery module and an inner surface portion of the battery case, the second surface portion constitutes a surface portion disposed along the first direction, the inner surface portion constitutes an inner surface facing the second surface portion, and the guide portion is provided on another one of the second surface portion and the inner surface portion. The guide portion is configured to include a linear portion that guides the protrusion along the first direction, and an inclined portion that is provided on one side in the first direction with respect to the linear portion and extends in an inclined manner toward a side of the first surface portion. Therefore, when the battery module is inserted into the battery case in the first direction through the opening of the battery case, the protrusion provided on one of the facing surfaces is guided by the guide portion provided on the other one of the facing surfaces. More specifically, the protrusion is guided along the linear portion and the inclined portion of the guide portion in an order of the linear portion and the inclined portion. Therefore, when the battery module is inserted into the far side of the battery case, the battery module moves toward the heat conduction member according to the inclination of the inclined portion. This allows the battery module to be pressed against the heat conduction member in an accommodation state of the battery module, thereby improving cooling performance. Furthermore, since the protrusion and the guide portion are provided on the battery module and the battery case, respectively, there is no need for a separately configured member. As a result, the battery module can be pressed against the heat conduction member without using a separately configured member.

A power storage device of a second aspect of the present disclosure, in the configuration described in the first aspect, is configured as follows: the first direction is set as a horizontal direction; the first surface portion is set as a lower surface portion of the battery module; and the guide portion is configured to include a linear portion provided on the inner surface portion of the battery case and extending along the horizontal direction, and an inclined portion provided on a far side in the horizontal direction with respect to the linear portion and extending to a lower side in an inclined manner toward a side of the first surface portion.

In the power storage device of the second aspect, the first direction is the horizontal direction, and therefore the battery module can be inserted in the horizontal direction from the opening of the battery case. Further, the first surface portion is the lower surface portion of the battery module, and the heat conduction member is disposed between the battery case and the first surface portion. Thus, as the battery module is inserted toward the far side of the battery case, the battery module moves to a lower side according to the inclination of the inclined portion and is pressed against the heat conduction member. Accordingly, the battery module can be pressed against the heat conduction member while utilizing the weight of the battery module itself. This makes it possible to facilitate the step during manufacturing and also to effectively improve the cooling performance in an accommodation state of the battery module.

A power storage device of a third aspect of the present disclosure, in the configuration described in the first or second aspect, is configured as follows: the linear portion of the guide portion is provided at a position where the first surface portion of the battery module is spaced apart from a facing surface in the battery case in a state in which the linear portion guides the protrusion.

In the power storage device of the third aspect, the linear portion of the guide portion is provided at a position where, in a state in which the linear portion guides the protrusion, the first surface portion of the battery module is spaced apart from the facing surface in the battery case. Therefore, in the state in which the protrusion of the battery module is guided by the linear portion of the guide portion, the battery module is supported by the guide portion and is thus in a floating state in the battery case. This allows the protrusion to be smoothly guided from the linear portion of the guide portion to the inclined portion when the battery module is guided toward the far side of the battery case.

A method for manufacturing a power storage device of a fourth aspect of the present disclosure is a method for manufacturing the power storage device described in the first aspect, and includes accommodating the battery module in the battery case by inserting the battery module into the battery case along the first direction and guiding the protrusion along the linear portion and the inclined portion in an order of the linear portion and the inclined portion.

In the method for manufacturing the power storage device of the fourth aspect, when the battery module is inserted into the battery case along the first direction, the protrusion is guided along the linear portion and the inclined portion of the guide portion on the battery case side, in an order of the linear portion and the inclined portion. Therefore, as the battery module is guided toward the far side of the battery case, the battery module moves toward a side of the heat conduction member disposed on the side of the first surface portion, according to the inclination of the inclined portion. As a result, in the method for manufacturing the power storage device, the battery module can be pressed against the heat conduction member in an accommodation state of the battery module, thereby improving cooling performance. Furthermore, since the protrusion and the guide portion are provided on the battery module and the battery case, respectively, there is no need for a separately configured member. As described above, in the method for manufacturing the power storage device, the battery module can be pressed against the heat conduction member without using a separately configured member.

As described above, the power storage device and the method for manufacturing the power storage device according to the present disclosure can press the battery module against the heat conduction member without using a separately configured member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view showing a power storage device partially exploded according to the present embodiment;

FIG. 2 is a side view of the power storage device according to the present embodiment, as viewed in the direction of arrow A in FIG. 1.

FIG. 3 is a cross-sectional view of the power storage device illustrating a state that is taken along line III-III in FIG. 2;

FIG. 4 is a schematic diagram showing a manufacturing step for assembling the power storage device of the present embodiment;

FIG. 5 is a view illustrating a first modification of the power storage device of the present embodiment, and is a cross-sectional view of the power storage device corresponding to FIG. 3;

FIG. 6 is a schematic diagram showing a manufacturing step for assembling the power storage device according to the first modification;

FIG. 7 is a view illustrating a second modification of the power storage device of the present embodiment, and is a cross-sectional view of the power storage device corresponding to FIG. 3;

FIG. 8A is a view illustrating a power storage device according to a third modification, and is a schematic side view of a battery module; and FIG. 8B is a view illustrating a power storage device according to a fourth modification, and is a schematic cross-sectional view showing the inside of a battery case.

### DETAILED DESCRIPTION OF EMBODIMENTS

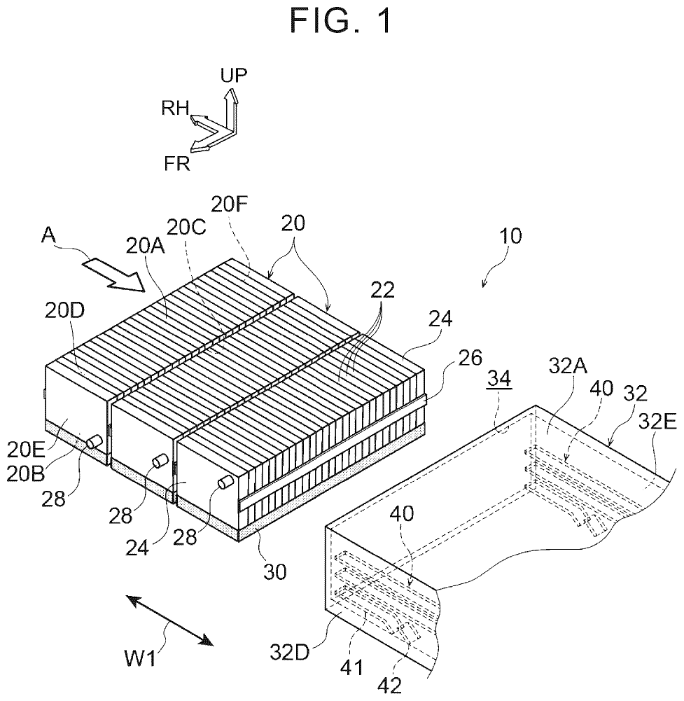

Hereinafter, the power storage device 10 according to the present embodiment will be described with reference to FIGS. 1 to 8B. In addition, an arrow FR shown appropriately in each drawing indicates the front side of the power storage device 10, an arrow UP indicates the upper side of the device, and an arrow RH indicates the right side of the device. In addition, in the following description, unless otherwise specified, when the directions of front-rear, up-down, left-right, and right-left are used, such directions refer to front-rear in the front-rear direction of the device, up-down in the up-down direction of the device, and left-right in the left-right direction of the device.

In addition, unless otherwise specified in the specification, each element is not limited to one, and may be present in multiples. In the drawings, substantially identical elements are given the same reference numerals, and duplicate explanations in the specification will be omitted.

The power storage device 10 according to the present embodiment is not limited to a specific use and can be applied to various devices. In the present embodiment, as an example, the power storage device 10 is mounted on a battery electric vehicle that runs using the driving force of an electric motor, and supplies driving power to the electric motor. Examples of battery electric vehicles include hybrid electric vehicles (HEVs), plug-in hybrid electric vehicles (PHEVs), battery electric vehicles (BEVs), and fuel cell electric vehicles (FCEVs).

FIG. 1 is an exploded perspective view showing a power storage device partially exploded. As shown in FIG. 1, the power storage device 10 includes a battery module 20, a battery case 32, and a heat conduction member 30.

### Battery Module

The battery module 20 includes a plurality of battery cells 22 arranged side by side in one direction, and is configured by restraining the battery cells 22 from both sides with a pair of end plates 24, and connecting the end plates 24 with a pair of side plates 26.

Each battery cell 22 is, for example, a lithium ion secondary battery, and an electrode body, not shown, is accommodated inside the exterior body. The electrode body includes one or more laminates formed by laminating a positive electrode current collector, a positive electrode active material layer, an electrolyte layer, a negative electrode active material layer, a negative electrode current collector, a negative electrode active material layer, an electrolyte layer, and a positive electrode active material layer, none of which are shown in the figure, in this order. The positive electrode current collector and the negative electrode current collector are each a metal foil in a sheet shape. The positive electrode active material layer is a layer in a sheet shape containing a positive electrode active material. The negative electrode active material layer is a layer in a sheet shape containing a negative electrode active material. The electrolyte layer is a layer in a sheet shape containing an electrolyte, and the electrolyte may be either liquid or solid.

The battery cells 22 are electrically connected to each other by bus bars or the like not shown in the figure.

The end plates 24 are plate-shaped members that restrain the battery cells 22 that are arranged side by side in one direction. In the present embodiment, the battery cells 22 are arranged in the front-rear direction, and the end plates 24 are disposed at the front and rear of a stacked body in which the battery cells 22 are arranged. The end plates 24 are configured to apply a predetermined restraining pressure to the stacked body from the front-rear direction.

The side plates 26 are plate-shaped members that extend long along the stacking direction (front-rear direction) of the battery cells 22, and connect the end plates 24 in the front-rear direction.

The battery module 20 has a rectangular shape with the front-rear direction as its longitudinal direction, and includes an upper surface portion 20A, a lower surface portion 20B, a left surface portion 20C, a right surface portion 20D, a front surface portion 20E, and a rear surface portion 20F.

### Heat Conduction Member

Here, the heat conduction member 30 is fixed to the lower surface portion 20B of the battery module 20. The heat conduction member 30 is preferably a member having excellent thermal conductivity and flexibility such that it undergoes compressive deformation (or elastic deformation) when subjected to a predetermined pressure. One example of such a heat conduction member 30 is a sheet-shaped member made of a thermal interface material (TIM) having excellent thermal conductivity. The TIM is a material with improved thermal conductivity as a sheet by filling a resin, such as silicone and epoxy, with a high heat conduction filler.

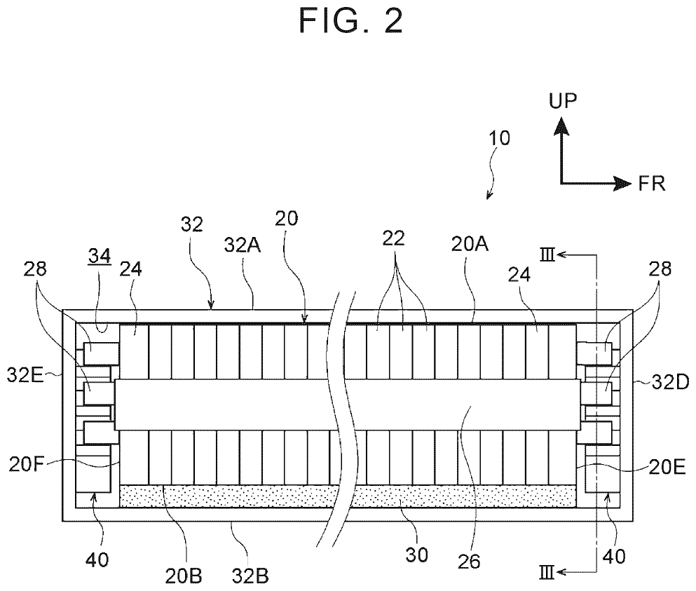

The heat conduction member 30 of the present embodiment has a sheet shape made by filling a resin, such as silicone, with a high heat conduction filler, and is configured to be elastically deformable by a predetermined pressing force. In a manufacturing step described below, the heat conduction member 30 is elastically deformed when the lower surface portion 20B of the battery module 20 is pressed against a lower wall portion 32B of the battery case, and is brought into close contact with an inner surface of the battery case 32 (see FIG. 2). The lower surface portion 20B is an example of a “first surface portion constituting a surface portion disposed along the first direction” in the present disclosure.

### Protrusion

A protrusion 28 for guiding the battery module 20 into the battery case 32 is provided on the front surface portion 20E and the rear surface portion 20F of the battery module 20. The battery module 20 is accommodated at a predetermined position within the battery case 32 by the protrusion 28 sliding along a guide portion 40 within the battery case 32 described below. In each drawing, only the protrusion 28 provided on the front surface portion 20E of the battery module 20 is shown, and the protrusion 28 on the rear surface portion 20F of the battery module 20 is omitted.

The front surface portion 20E and the rear surface portion 20F are each an example of a “second surface portion constituting a surface portion disposed along the first direction” in the present disclosure.

As an example, the protrusion 28 is configured by a columnar protrusion protruding outward in the front-rear direction from the front surface portion 20E and the rear surface portion 20F. In the present embodiment, the protrusion 28 is provided on each of the end plates 24. The height positions of the protrusions 28 of the battery modules 20 are set to differ depending on the accommodation positions of the battery modules 20 within the battery case 32.

As shown in FIGS. 1 and 2, in the present embodiment, three battery modules 20 are accommodated in the battery case 32 and arranged side by side in the first direction W1 (horizontal direction, left-right direction). Accordingly, inside the battery case 32, the three protrusions 28 (28A, 28B, and 28C) are disposed side by side in the first direction W1. The protrusions 28 of the battery modules 20 are arranged in positions that do not overlap with each other in the first direction W1 (left-right direction) and in the up-down direction. In the present embodiment, the height position of the protrusion 28 is set to be higher as the battery module 20 is disposed further on the far side in the first direction W1 in the battery case 32. The above arrangement of the protrusions 28 is merely an example and can be appropriately modified. For example, the height position of the protrusion 28 may be set lower as the battery module 20 is disposed further on the far side in the first direction W1 in the battery case 32.

Although not shown, a bus bar not shown is connected to the upper surface portion 20A of the battery module 20. The battery modules 20 accommodated in the battery case 32 are electrically connected via the bus bar.

### Battery Case

As shown in FIGS. 1 and 2, the battery case 32 has a flat box shape that is open in one direction, and includes an upper wall portion 32A, a lower wall portion 32B, a left wall portion 32C, a front wall portion 32D, and a rear wall portion 32E. The battery case 32 is made of, for example, metal. The battery case 32 of the present embodiment has an opening 34 at a right side portion and is configured to be open to the right side. Therefore, the battery module 20 is inserted from the opening 34 of the battery case 32 in the first direction W1 (horizontal direction) and accommodated inside the battery case 32.

The opening 34 of the battery case 32 is closed by a cover member 36 that is separately configured. The cover member 36 closes the opening 34 and applies a predetermined restraining pressure in the left-right direction to the battery modules 20 accommodated therein.

### Guide Portion

Here, the battery case 32 includes the guide portion 40 provided on the inner surface portion thereof in correspondence with the protrusion 28 of the battery module 20. Specifically, the guide portion 40 is provided on an inner surface portion (reference numeral omitted) that faces the front surface portion 20E (second surface portion) of the battery module 20 and an inner surface portion (reference numeral omitted) that faces the rear surface portion 20F (second surface portion) of the battery module 20. That is, the guide portion 40 is provided integrally on the inner surface portions of the front wall portion 32D and the rear wall portion 32E of the battery case 32, and is provided so as to protrude inward in the front-rear direction from the inner surfaces.

The guide portion 40 may be configured as a groove portion provided by recessing the inner surface portions of the front wall portion 32D and the rear wall portion 32E of the battery case 32 outward in the front-rear direction.

The guide portion 40 is provided in a long rail shape, and is configured to support the protrusion 28 of the battery module 20 in the battery case 32 such that the protrusion 28 is slidable. The guide portion 40 includes a linear portion 41 that guides the protrusion 28 of the battery module 20 along the first direction W1, and an inclined portion 42 provided on the far side in the first direction W1 (one side of the first direction W1) with respect to the linear portion 41.

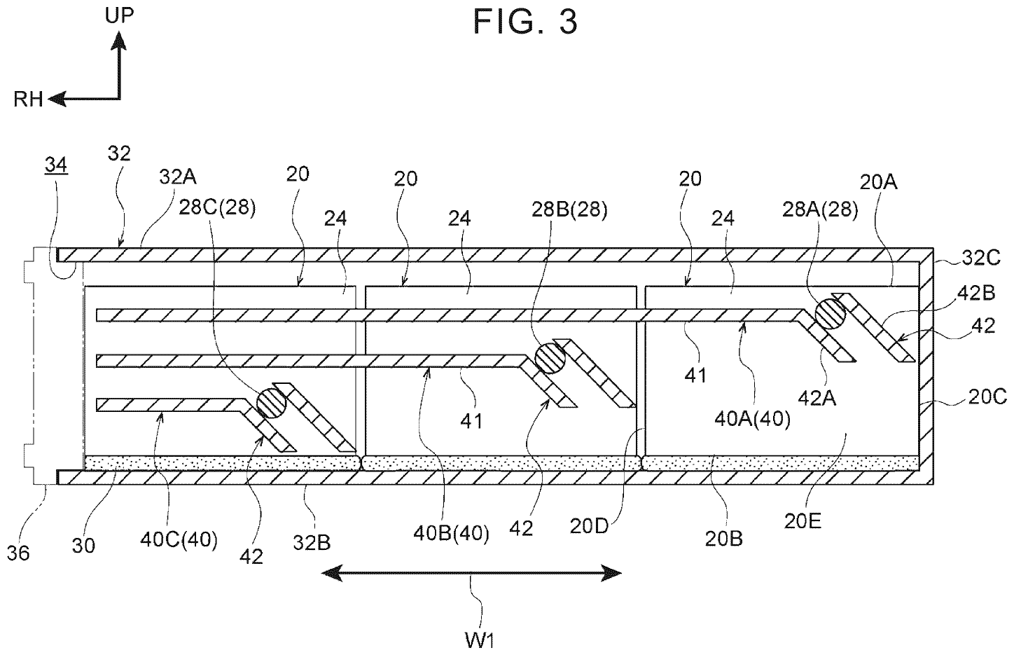

FIG. 3 is a cross-sectional view of the battery case 32 illustrating a state that is taken along line III-III in FIG. 2. As shown in FIG. 3, in the present embodiment, three guide portions 40A, 40B, and 40C are provided on the battery case 32 side in correspondence with the protrusions 28A, 28B, and 28C of the three battery modules 20 arranged in the battery case 32. The three guide portions 40 are arranged at positions not overlapping in the up-down direction. Further, the inclined portions 42 of the three guide portions 40 are disposed at positions not overlapping with each other in the first direction W1. In the following description, the three guide portions 40A, 40B, and 40C are collectively referred to as the guide portion 40 when they are not particularly distinguished from one another.

As an example, the linear portion 41 of each guide portion 40 has a shape of a single straight line extending, on the front wall portion 32D and the rear wall portion 32E of the battery case 32, from an end portion near the opening 34 toward the far side in the case. Furthermore, it is preferable that the linear portion 41 be provided at a position of height where the lower surface portion 20B of the battery module 20 is spaced apart from the facing surface (lower wall portion 32B) in the battery case 32 in a state in which the linear portion 41 guides the protrusion 28 (in a state in which the linear portion 41 supports the protrusion 28 from the lower side). This allows the protrusion 28 on the battery module 20 side to be reliably supported by the guide portion 40 of the battery case 32, and also makes it easier for the battery module 20 to slide via the protrusion 28. However, the present disclosure is not limited thereto, and the lower surface portion 20B of the battery module 20 may abut against the facing surface in the battery case 32 in a state in which the protrusion 28 is guided by the linear portion 41.

The inclined portion 42 of each guide portion 40 extends from an end portion of the linear portion 41 toward the far side in the case. The inclined portion 42 is inclined to the lower side toward a side of the lower surface portion 20B of the battery case 32, and includes a main inclined portion 42A and an auxiliary inclined portion 42B that each have a shape of a straight line and are arranged parallel to each other. The main inclined portion 42A is provided continuously with the linear portion 41, and the auxiliary inclined portion 42B is provided spaced apart from the linear portion 41. In addition, the main inclined portion 42A may be spaced apart from the linear portion 41.

When the battery module 20 is inserted into the far side of the battery case 32, the protrusion 28 provided on the battery module 20 is inserted between the main inclined portion 42A and the auxiliary inclined portion 42B and moves to the lower side. As a result, the battery module 20 moves to the lower side in the battery case 32, and the heat conduction member 30 fixed to the lower surface portion 20B of the battery module 20 is pressed against the lower wall portion 32B of the battery case 32.

### Method for Manufacturing the Power Storage Device

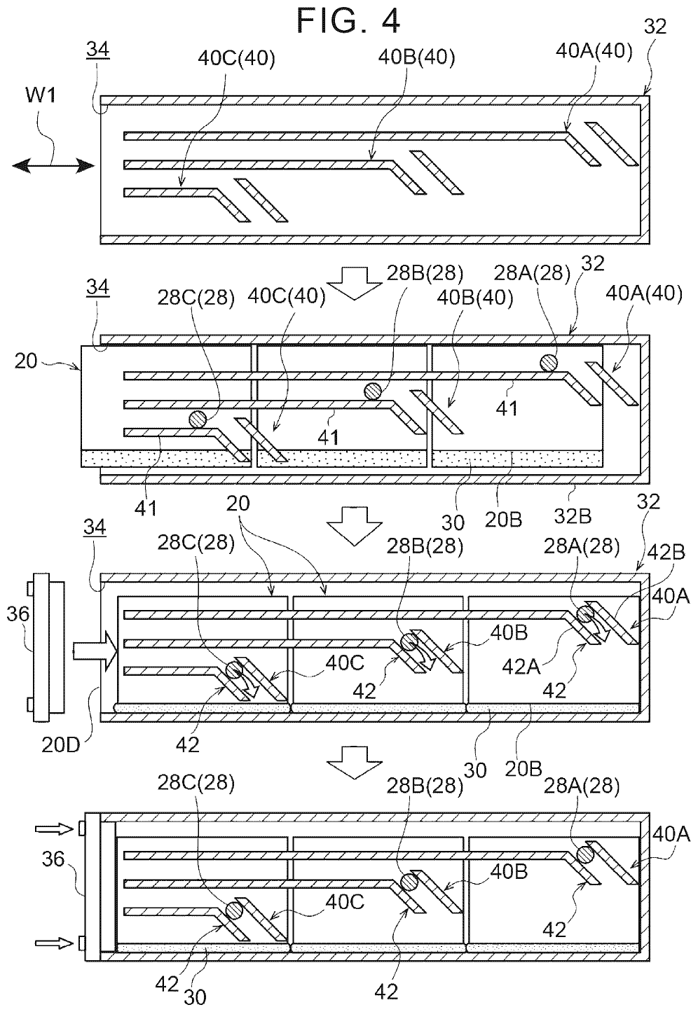

Next, a method for manufacturing the power storage device 10 will be described with reference to FIG. 4.

First, a step is performed in which the battery modules 20 accommodated in the battery case 32 are disposed side by side along the first direction W1 at a predetermined work position. In this case, the battery modules 20 having the protrusions 28 of different heights are arranged in order so as to correspond from a near side accommodation position close to the opening 34 of the battery case 32 to a far side accommodation position. The first direction W1 is, for example, the horizontal direction, and in the present embodiment, corresponds to the left-right direction of the device.

Next, a step is performed in which the left surface portion 20C of the battery module 20 accommodated at the furthest side of the case is positioned facing the opening 34 of the battery case 32, and the battery modules 20 are inserted into the battery case 32 in order, starting with the battery module 20 accommodated at the far side of the case. This step includes a step of guiding the protrusion 28 of the battery module 20 along the linear portion 41 and the inclined portion 42 of the guide portion 40 in an order of the linear portion 41 and the inclined portion 42, thereby accommodating the battery module 20 within the battery case 32. In this step, the three battery modules 20 may be inserted simultaneously by pushing them into the battery case 32 along the first direction W1, or they may be inserted one by one.

Each battery module is inserted into the battery case 32 through the opening 34 along the first direction W1. In this case, the protrusions 28 of each battery module 20 are supported and guided by the corresponding guide portions 40.

Specifically, the guide portion 40A provided at the highest position in the battery case 32 is configured to guide the protrusion 28A of the battery module 20 accommodated in the left side portion in the battery case 32, as an example. Further, the second guide portion 40B provided on the lower side of the guide portion 40A is configured to guide the protrusion 28B of the battery module 20 accommodated in the center portion in the battery case 32. Further, the third guide portion 40C provided on the lower side of the guide portion 40B is configured to guide the protrusion 28C of the battery module 20 accommodated in the right side portion in the battery case 32.

In the battery case 32, when the protrusions 28 are supported by the linear portions 41, the lower surface portions 20B of the battery modules 20 are disposed spaced apart from the lower wall portion 32B of the battery case 32. Thereafter, the protrusions 28 of the battery modules 20 are slid along the guide portions 40 and guided along the linear portions 41 and the inclined portions 42.

When the protrusion 28 is guided along the inclined portion 42, the battery module 20 move toward the far side and the lower side in the case. As a result, the heat conduction member 30 disposed on the lower surface portion 20B of the battery module 20 is pressed against the lower wall portion 32B of the battery case 32.

After the three battery modules 20 are accommodated in the battery case 32, the opening 34 of the battery case 32 is closed with the cover member 36. In this case, the side surface of the cover member 36 on the inside of the case presses the battery module 20 accommodated in the right side portion of the battery case 32 to the left side. As a result, the heat conduction member 30 disposed on the lower surface portion 20B of the battery module 20 is pressed further to the lower side by the restraining pressure applied by the cover member 36 and the weight of the battery module 20 itself.

After going through the above steps, the heat conduction member 30 disposed between the battery module 20 and the battery case 32 is compressed at a predetermined compression rate and is in close contact with the lower wall portion 32B of the battery case 32, thus completing the assembly of the power storage device 10.

### Operations and Effects

As described above, the power storage device 10 of the present embodiment includes the battery case 32 serving as a housing, and at least one battery module 20 configured to be insertable in the first direction W1 from the opening 34 of the battery case 32 and accommodated inside the battery case 32. Further, the power storage device 10 includes the heat conduction member 30 disposed between the battery module 20 and the battery case 32 in a state in which the battery module 20 is accommodated in the battery case 32. The heat conduction member 30 is disposed between the lower surface portion 20B (first surface portion) of the battery module and the battery case 32, and the lower surface portion 20B constitutes a surface portion disposed along the first direction W1. As a result, heat generated during charging and discharging of the battery module 20 is transferred to the battery case 32 via the heat conduction member 30, and is dissipated from the battery case 32 to the outside, thereby cooling the battery module 20.

Here, the power storage device 10 includes the protrusion 28 provided on the battery module 20 and the guide portion 40 provided on the inner surface portion of the battery case 32 in correspondence with the protrusion 28. The protrusion 28 is provided on the front surface portion 20E and the rear surface portion 20F (second surface portion) of the battery module 20, which are disposed along the first direction W1. In addition, the guide portion 40 is configured to include the linear portion 41 that guides the protrusion 28 of the battery module 20 along the first direction W1, and the inclined portion 42 that is provided on one side in the first direction W1 with respect to the linear portion 41 and extends in an inclined manner toward a side of the lower surface portion 20B. Therefore, when the battery module 20 is inserted into the battery case 32 in the first direction W1 through the opening 34 of the battery case 32, the protrusion 28 provided on one of the facing surfaces is guided by the guide portion 40 provided on the other one of the facing surfaces. More specifically, the protrusion 28 is guided along the linear portion 41 and the inclined portion 42 of the guide portion 40 in an order of the linear portion 41 and the inclined portion 42. Therefore, when the battery module 20 is inserted toward the far side of the battery case 32, the battery module 20 moves toward a side of the heat conduction member 30 according to the inclination of the inclined portion 42. This allows the battery module to be pressed against the heat conduction member 30 in an accommodation state of the battery module 20, thereby improving the cooling performance. Furthermore, since the protrusion 28 and guide portion 40 are provided on the battery module 20 and the battery case 32, respectively, there is no need for a separately configured member. As a result, the battery module 20 can be pressed against the heat conduction member 30 without using a separately configured member.

In addition, in the present embodiment, since the first direction W1 is the horizontal direction, the battery module 20 can be inserted horizontally from the opening 34 of the battery case 32. In addition, the heat conduction member 30 is disposed between the lower surface portion 20B of the battery module 20 and the battery case 32. Therefore, as the battery module 20 is inserted toward the far side of the battery case 32, the battery module 20 moves to the lower side according to the inclination of the inclined portion 42 and is pressed against the heat conduction member 30. Accordingly, the battery module 20 can be pressed against the heat conduction member 30 by utilizing the weight of the battery module 20 itself. This makes the manufacturing step easier, and ensures a sufficient compressibility of the heat conduction member 30 in an accommodation state of the battery module 20, thereby effectively improving the cooling performance.

Although one embodiment according to the present disclosure has been described above, the present disclosure is not limited thereto. Hereinafter, modifications that can be applied to the embodiment will be listed and described. In each of the modifications, the same components are given the same reference numerals and the description thereof will be omitted.

### First Modification

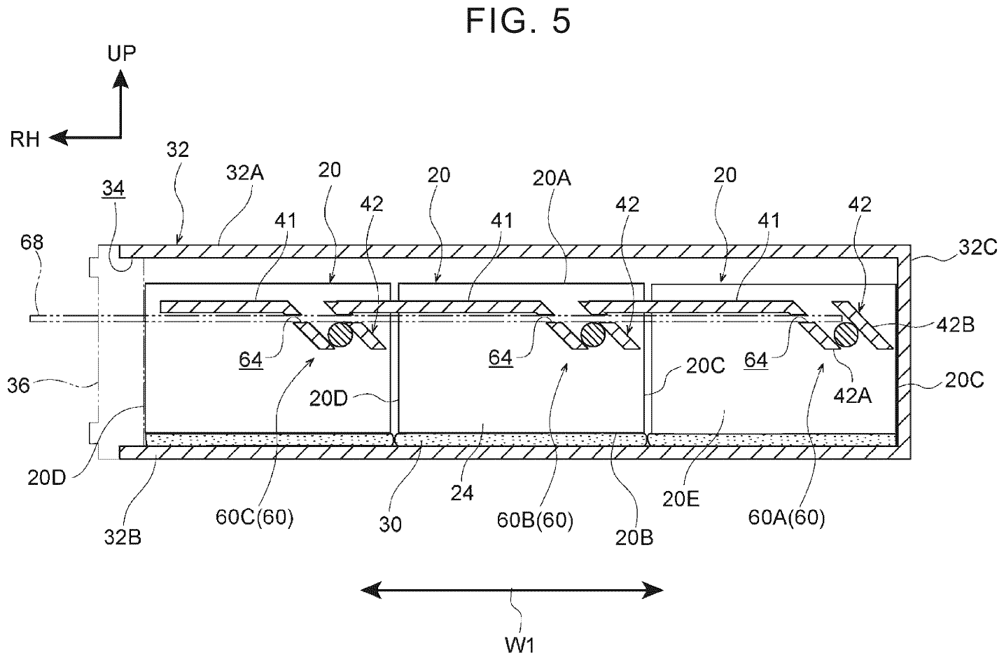

In the embodiment, the protrusions 28 of the battery modules 20 accommodated in the battery case 32 are configured to be disposed at different heights in the up-down direction, but the present disclosure is not limited thereto. As shown in FIG. 5, a configuration may be such that a plurality of protrusions 50 (50A, 50B, and 50C) is set at the same height position.

In this case, the guide portions 60 (60A, 60B, and 60C) provided on the inner surface of the battery case 32 are also set at the same height position. Here, the guide portion 60 according to the first modification is provided with a linear portion 41 and a main inclined portion 42A that are spaced apart from each other, and includes a stopper opening 64 between the linear portion 41 and the main inclined portion 42A. The diameter of the stopper opening 64 is set to be smaller than the diameter of the protrusion 28 provided on the battery module 20 side.

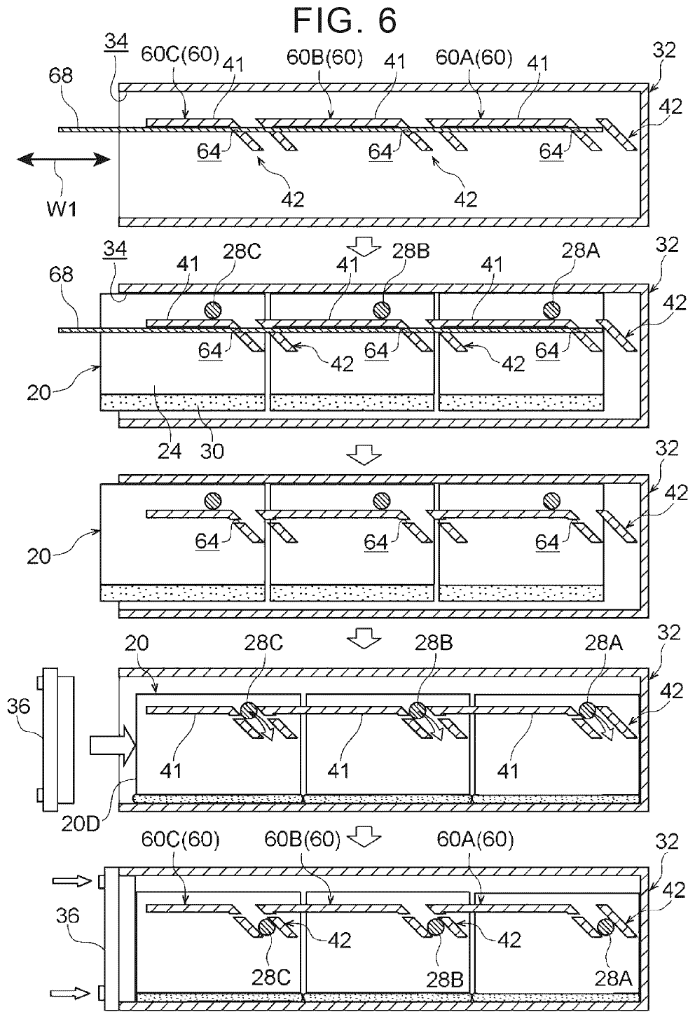

As shown in FIG. 6, in the manufacturing step according to the first modification, a step is performed in which a rod-shaped stopper member 68 that passes through the three stopper openings 64 in the battery case 32 is inserted to block the gaps between adjacent linear portions 41. Thereafter, a step is performed in which the three battery modules 20 are inserted into the battery case 32 along the first direction W1. In this case, since the gaps between the adjacent linear portions 41 are blocked by the stopper member 68, the movement of the protrusions 28 through the gaps between the adjacent linear portions 41 is restricted.

Next, a step is performed in which the stopper member 68 is removed from the inside of the battery case 32, and the movement of the protrusions 28 through the gaps between the adjacent linear portions 41 is permitted. As a result, each protrusion 28 is guided between the main inclined portion 42A and the auxiliary inclined portion 42B of the corresponding guide portion 60, allowing the battery module 20 to move to the lower side.

The first modification can also provide the same operations and effects as those of the embodiment. Further, in the first modification, the protrusions 28 of battery modules 20 can be provided at the same position, and thus the battery modules 20 have excellent versatility.

### Second Modification

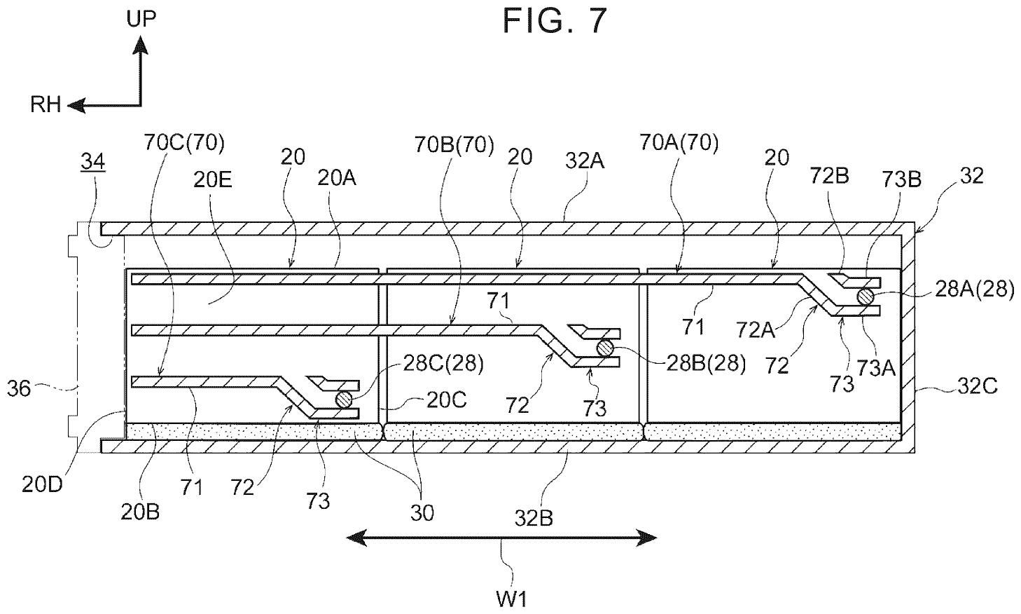

In the embodiment, the guide portion 40 has one linear portion 41, but the present disclosure is not limited thereto. As shown in FIG. 7, a configuration may be such that two linear portions are disposed with an inclined portion therebetween. The guide portions 70 (70A, 70B, and 70C) shown in FIG. 7 are each configured with a first linear portion 71, an inclined portion 72, and a second linear portion 73.

The first linear portion 71 has a shape of a single straight line, and guides the protrusion 28 of the battery module 20 along the first direction W1. The inclined portion 72 is provided on the far side in the first direction W1 with respect to the first linear portion 71, and is configured by a main inclined portion 72A and an auxiliary inclined portion 72B that extend in an inclined manner toward the lower surface portion 20B (first surface portion) of the battery module 20. The second linear portion 73 has a shape of two parallel straight lines, and is provided on the far side in the first direction W1 with respect to the inclined portion 72. The second linear portion 73 is configured by a main linear portion 73A provided continuously with the inclined portion 72, and an auxiliary linear portion 73B provided spaced apart from the inclined portion 72, and guides the protrusion 28 of the battery module 20 along the first direction W1 at a position closer to the lower surface portion 20B than the first linear portion 71.

According to the second modification, when inserted into the battery case 32, the protrusions 28 of the battery modules 20 accommodated in the battery case 32 are guided via the first linear portion 71 and the inclined portion 72 of the guide portion 70 to the second linear portion 73 extending in the horizontal direction (see FIG. 7) . As a result, the heights of the battery modules 20 can be adjusted by the support of the second linear portion 73, and the displacement of the position of the battery modules 20 in the battery case 32 in the up-down direction is suppressed.

### Third Modification

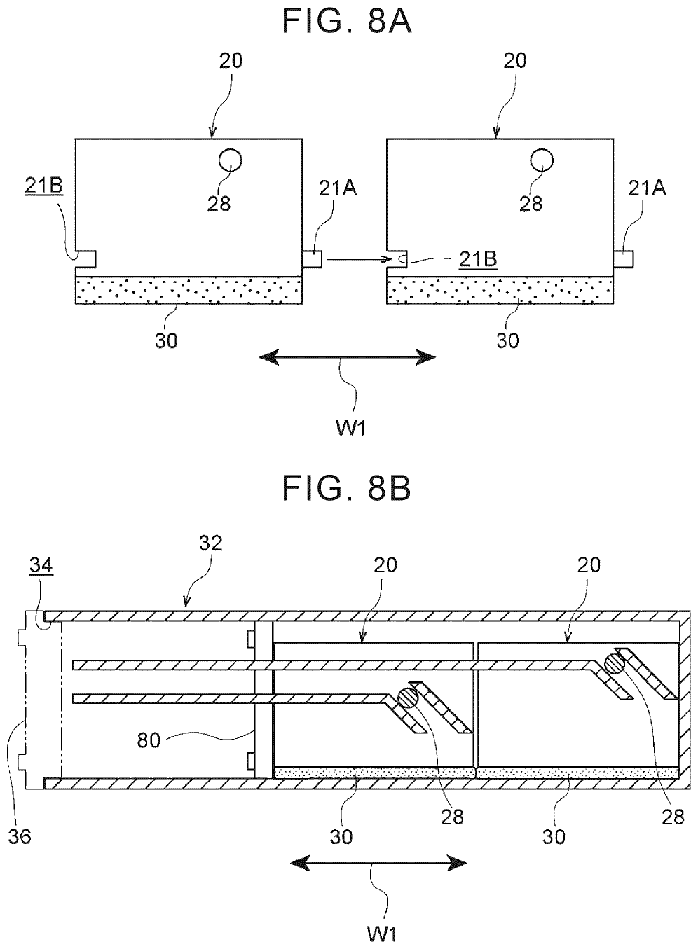

As shown in FIG. 8A, a configuration may be such that a fitting protrusion 21A is provided on one of the battery modules 20 adjacent to each other in the first direction W1 in the battery case 32, and a fitting recess 21B is provided on the other battery module. In this configuration, by fitting the fitting protrusion 21A into the fitting recess 21B, the battery modules 20 can be coupled in the first direction and inserted into the battery case 32. As a result, when the battery modules 20 are inserted together into the battery case 32, the positional displacement of each battery module 20 in the up-down direction is suppressed.

Although not shown, the coupling means between adjacent battery modules 20 may be a bus bar having sufficient strength.

### Fourth Modification

In the embodiment, the cover member 36 that closes the opening 34 of the battery case 32 is configured to restrain the battery modules 20 in the horizontal direction, but the present disclosure is not limited thereto. As shown in FIG. 8B, a configuration may be such that a middle plate member 80 that partitions the inside of the case may be inserted into the battery case 32, and the middle plate member 80 restrains the battery modules 20 in the horizontal direction. In such a configuration, sensors for voltage monitoring, control devices, and the like can be mounted in the empty space in the battery case 32.

### Supplementary Explanation

In addition, each configuration of the embodiment can be modified as appropriate without departing from the spirit of the present disclosure.

For example, in the embodiment, the lower surface portion 20B of the battery module 20 is described as the “first surface portion”, but this is not limited thereto. Which surface is the “first surface portion” can be appropriately modified depending on the position of the opening 34 of the battery case 32. The same is also applied to the position of the heat conduction member 30 disposed between the lower surface portion 20B (first surface portion) of the battery module 20 and the battery case 32.

In the embodiment, the front surface portion 20E and the rear surface portion 20F of the battery module 20 are described as the “second surface portion”, but the present disclosure is not limited thereto. Which surface is the “second surface portion” can be appropriately modified depending on the position of the opening 34 of the battery case 32. The same is also applied to the positions of the protrusions 28 provided on the front surface portion 20E and the rear surface portion 20F (second surface portion) of the battery module 20. The protrusion 28 may be provided on either the front surface portion 20E or the rear surface portion 20F.

In the embodiment, the heat conduction member 30 is configured to be fixed to the lower surface portion 20B of the battery module 20, but the present disclosure is not limited thereto. The heat conduction member 30 may be configured separately from the battery module 20. In this case, the heat conduction member 30 may be configured to be fixed to the lower wall portion 32B in the battery case 32 in advance.

Further, the configurations of the battery module 20 described in the embodiment and each of the modifications are merely examples and are not essential. For example, the battery cells 22 may be rectangular cells or cylindrical cells.

Further, in the battery module, the battery cells 22 may be stacked in the left-right direction, or may be stacked in the up-down direction. When the battery cells 22 are stacked in the left-right direction or up-down direction, the protrusions 28, 50 may be configured to be provided on the side plates 26.

Further, in the embodiment and each of the modifications, the protrusions 28, 50 are provided on the battery module 20, and the guide portions 40, 60, and 70 are provided on the inner surface portion of the battery case 32, but the present disclosure is not limited thereto. The protrusion may be provided on the battery case, and the guide portion may be provided on the battery module. In this case, the guide portion may be configured to include a linear portion that guides the protrusion along the first direction W1, and an inclined portion that is provided on one side in the first direction W1 with respect to the linear portion and extends in an inclined manner toward a side of the first surface portion. Moreover, the “one side in the first direction” may be the near side in the first direction (i.e., the near side in the insertion direction of the battery module).

In addition, in the embodiment, the battery cell 22 is configured by a lithium secondary battery, but the battery cell is not limited thereto, and any known type of battery can be appropriately applied.

What is claimed is:

1. A power storage device comprising:
a battery case serving as a housing;
at least one battery module configured to be insertable in a first direction from an opening of the battery case and accommodated inside the battery case;
a heat conduction member disposed between the battery case and a first surface portion of the battery module in a state in which the battery module is accommodated in the battery case, the first surface portion constituting a surface portion disposed along the first direction; and
a protrusion and a guide portion, the protrusion being provided on one of a second surface portion of the battery module and an inner surface portion of the battery case, the second surface portion constituting a surface portion disposed along the first direction, the inner surface portion facing the second surface portion, and the guide portion being provided on another one of the second surface portion and the inner surface portion, wherein the guide portion is configured to include a linear portion that guides the protrusion along the first direction, and an inclined portion that is provided on one side in the first direction with respect to the linear portion and extends in an inclined manner toward a side of the first surface portion.

2. The power storage device according to claim 1, wherein:
the first direction is set as a horizontal direction;
the first surface portion is set as a lower surface portion of the battery module; and
the guide portion is configured to include a linear portion provided on the inner surface portion of the battery case and extending along the horizontal direction, and an inclined portion provided on a far side in the horizontal direction with respect to the linear portion and extending to a lower side in an inclined manner toward a side of the first surface portion.

3. The power storage device according to claim 1, wherein the linear portion of the guide portion is provided at a position where the first surface portion of the battery module is spaced apart from a facing surface in the battery case in a state in which the linear portion guides the protrusion.

4. A method for manufacturing the power storage device according to claim 1, the method comprising accommodating the battery module in the battery case by inserting the battery module into the battery case along the first direction and guiding the protrusion along the linear portion and the inclined portion in an order of the linear portion and the inclined portion.
